(19) United States
(12) Patent Application Publication
(10) Pub. No.: US 2025/0196500 A1
(43) Pub. Date: Jun. 19, 2025

(54) Liquid Ejecting Head And Liquid Ejecting Apparatus

(71) Applicant: SEIKO EPSON CORPORATION, Tokyo (JP)

(72) Inventor: Motoki TAKABE, Shiojiri (JP)

(21) Appl. No.: 18/978,508

(22) Filed: Dec. 12, 2024

(30) Foreign Application Priority Data
Dec. 13, 2023 (JP) 2023-210268

(51) Int. Cl. B41J 2/14

(52) U.S. Cl. CPC B41J 2/14233; B41J 2002/14491

(57) ABSTRACT

A liquid ejecting head includes: a nozzle substrate provided with a nozzle for ejecting a liquid; a pressure chamber substrate provided with a plurality of pressure chambers for applying pressure to the liquid; a piezoelectric element including a piezoelectric body, an individual electrode individually provided for each of the plurality of pressure chambers, and a common electrode provided in common to the plurality of pressure chambers; and a wiring substrate provided with an individual wiring line for applying a voltage to the individual electrode, a common wiring line for applying a voltage to the common electrode, and an auxiliary wiring line that is electrically coupled to the common wiring line to reduce resistance of the common electrode.

The present application is based on, and claims priority from JP Application Serial Number 2023-210268, filed Dec. 13, 2023, the disclosure of which is hereby incorporated by reference herein in its entirety.

### BACKGROUND

### 1. Technical Field

The present disclosure relates to a liquid ejecting head and a liquid ejecting apparatus.

### 2. Related Art

A technique for reducing resistance of a common electrode is known in a liquid ejecting head including a piezoelectric element that includes a plurality of pressure chambers for applying pressure to a liquid, an individual electrode individually provided for each of the plurality of pressure chambers, a common electrode provided in common to the plurality of pressure chambers, and a piezoelectric body. For example, JP-A-2021-24151 discloses a technique for reducing resistance of a common electrode by stacking an auxiliary electrode on the common electrode in a recess of a protection portion in a liquid ejecting head.

However, according to the related art, even when a height of the common electrode is increased in order to reduce the resistance, the height can only be increased to a height range of the recess. Therefore, the resistance may not be sufficiently reduced. By making the protection portion itself thicker and also making the recess thicker, the resistance can be reduced because there is a margin in the height range, but this poses an issue of increasing a thickness of the liquid ejecting head.

### SUMMARY

According to an aspect of the present disclosure, there is provided a liquid ejecting head including: a nozzle substrate provided with a nozzle for ejecting a liquid; a pressure chamber substrate provided with a plurality of pressure chambers for applying pressure to the liquid; a piezoelectric element including a piezoelectric body, an individual electrode individually provided for each of the plurality of pressure chambers, and a common electrode provided in common to the plurality of pressure chambers; and a wiring substrate provided with an individual wiring line for applying a voltage to the individual electrode, a common wiring line for applying a voltage to the common electrode, and an auxiliary wiring line that is electrically coupled to the common wiring line to reduce resistance of the common electrode.

In addition, according to another aspect of the present disclosure, there is provided a liquid ejecting apparatus including: the liquid ejecting head described above; and a control device that controls an ejection operation of the liquid from the liquid ejecting head.

### BRIEF DESCRIPTION OF THE DRAWINGS

FIG. 1 is an explanatory diagram showing a liquid ejecting apparatus according to the present embodiment.

FIG. 2 is an exploded perspective view of a liquid ejecting head.

FIG. 3 is a cross-sectional view taken along line III-III in FIG. 2.

FIG. 4 is a plan view of the liquid ejecting head.

FIG. 5 is a cross-sectional view taken along line V-V in FIG. 4.

FIG. 6 is a cross-sectional view taken along line VI-VI in FIG. 4.

FIG. 7 is a configuration diagram of a wiring substrate.

FIG. 8 is a configuration diagram of the wiring substrate.

FIG. 9 is a plan view of a liquid ejecting head.

FIG. 10 is a plan view of a liquid ejecting head.

FIG. 11 is a configuration diagram of a wiring substrate.

FIG. 12 is a configuration diagram of the wiring substrate.

### DESCRIPTION OF EMBODIMENTS

### 1: First Embodiment

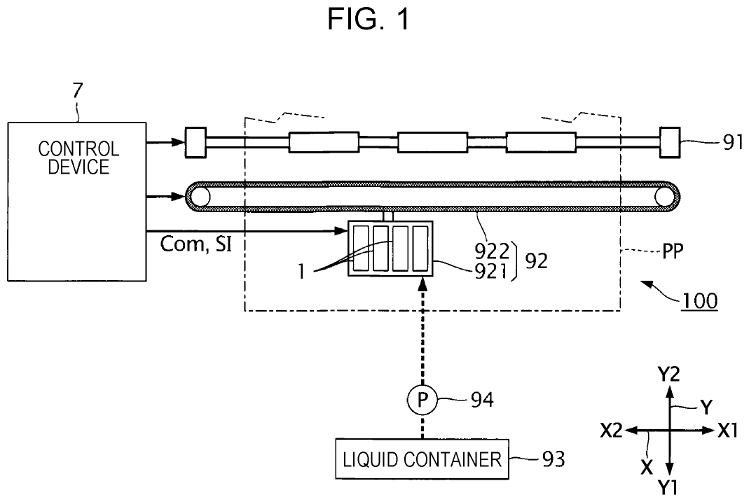

Hereinafter, a liquid ejecting apparatus 100 according to a first embodiment will be described with reference to FIGS. 1 to 8.

### 1-1: Overview of Liquid Ejecting Apparatus

FIG. 1 is an explanatory diagram showing a liquid ejecting apparatus 100 according to the present embodiment.

The liquid ejecting apparatus 100 is an ink jet printing apparatus that ejects ink onto a medium PP. Although the medium PP is typically printing paper, any print target, such as a resin film or fabric, may be used as the medium PP.

The liquid ejecting apparatus 100 includes a liquid container 93 that stores ink. As the liquid container 93, for example, a cartridge that can be attached to and detached from the liquid ejecting apparatus 100, a bag-shaped ink pack formed of a flexible film, an ink tank that can be replenished with ink, or the like can be employed. The liquid container 93 stores a plurality of types of ink with different colors.

The liquid ejecting apparatus 100 includes a plurality of liquid ejecting heads 1, a control device 7, a transport mechanism 91, a movement mechanism 92, and a supply mechanism 94.

The control device 7 includes, for example, a processing circuit, such as a CPU or an FPGA, and a storage circuit, such as a semiconductor memory, and controls each element of the liquid ejecting apparatus 100. Here, the CPU is an abbreviation for a central processing unit, and the FPGA is an abbreviation for a field programmable gate array.

The transport mechanism 91 transports the medium PP in a Y1 direction along a Y axis under the control of the control device 7. Hereinafter, the Y1 direction and a Y2 direction opposite to the Y1 direction will be collectively referred to as a Y axis direction. Additionally, hereinafter, an X1 direction along an X axis that intersects the Y axis and an X2 direction opposite to the X1 direction will be collectively referred to as an X axis direction. Further, hereinafter, a Z1 direction along a Z axis that intersects the X axis and the Y axis and a Z2 direction opposite to the Z1 direction will be collectively referred to as a Z axis direction. In the present embodiment, as an example, descriptions will be made assuming that the X axis, the Y axis, and the Z axis are orthogonal to each other. However, the present disclosure is not limited to such an aspect. The X axis, the Y axis, and the Z axis need only intersect each other.

The movement mechanism 92 reciprocates the plurality of liquid ejecting heads 1 in the X1 direction and the X2 direction under the control of the control device 7. The movement mechanism 92 includes a storage case 921 that accommodates the plurality of liquid ejecting heads 1, and an endless belt 922 to which the storage case 921 is fixed. The liquid container 93 may be stored in the storage case 921 together with the liquid ejecting head 1.

The supply mechanism 94 supplies the ink stored in the liquid container 93 to the liquid ejecting head 1 under the control of the control device 7. Under the control of the control device 7, the supply mechanism 94 may supply the ink stored in the liquid container 93 to the liquid ejecting head 1, collect the ink stored in the liquid ejecting head 1, and recirculate the collected ink back to the liquid ejecting head 1.

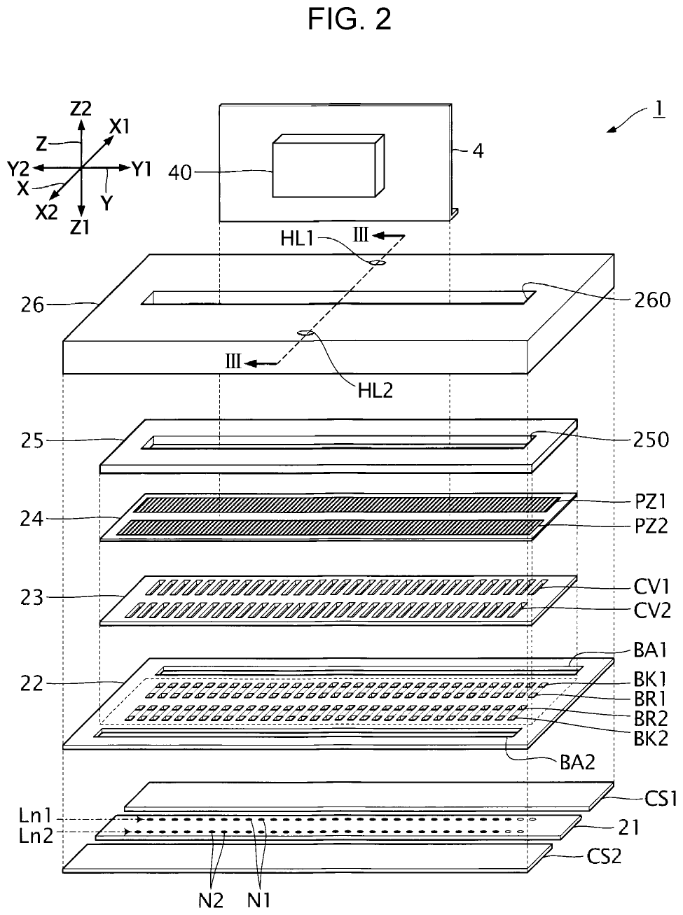

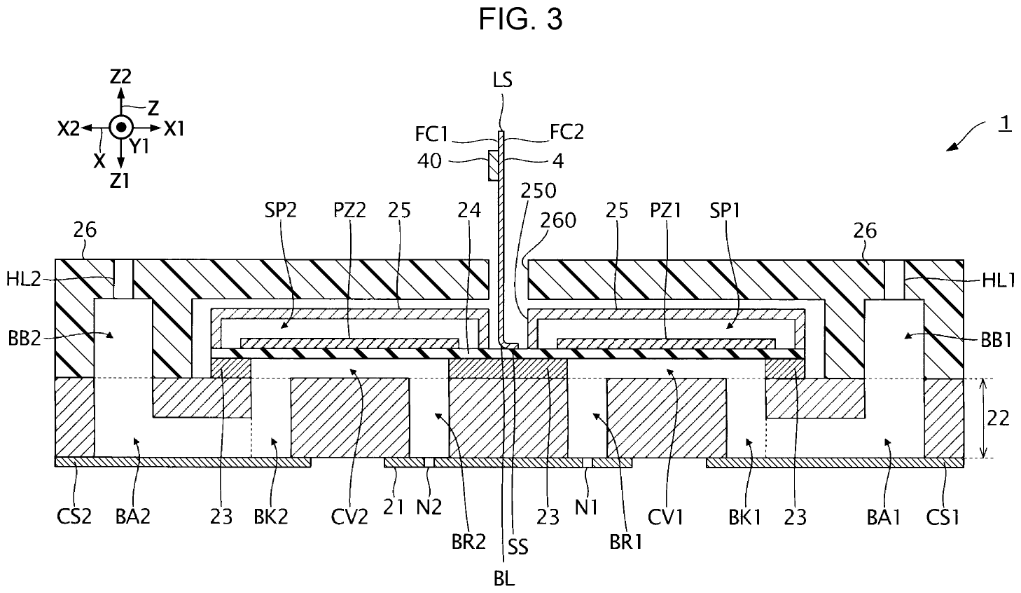

The control device 7 supplies the liquid ejecting head 1 with a drive signal Com for driving the liquid ejecting head 1 and a control signal SI for controlling the liquid ejecting head 1. The liquid ejecting head 1 is driven by the drive signal Com under the control of the control signal SI to eject the ink in the Z1 direction from some or all of a plurality of nozzles N provided in the liquid ejecting head 1. That is, the liquid ejecting head 1 ejects the ink from some or all of the plurality of nozzles N in conjunction with the transport of the medium PP by the transport mechanism 91 and the reciprocation of the liquid ejecting head 1 by the movement mechanism 92, and lands the ejected ink onto a surface of the medium PP, thereby forming a desired image on the surface of the medium PP. The nozzles N will be described below with reference to FIGS. 2 and 3.

### 1-2: Overview of Liquid Ejecting Head

The overview of the liquid ejecting head 1 will be described below with reference to FIGS. 2 and 3.

FIG. 2 is an exploded perspective view of the liquid ejecting head 1. FIG. 3 is a cross-sectional view taken along line III-III in FIG. 2.

The liquid ejecting head 1 includes a nozzle substrate 21, compliance sheets CS1 and CS2, a communication plate 22, a pressure chamber substrate 23, a diaphragm 24, a sealing substrate 25, a flow path forming substrate 26, and a wiring substrate 4, as shown in FIGS. 2 and 3.

The nozzle substrate 21 is a plate-like member that is elongated in the Y axis direction and that extends substantially parallel to an XY plane, as shown in FIG. 2. Here, “substantially parallel” is a concept that includes not only being completely parallel but also being regarded as parallel when taking into consideration errors. In the present embodiment, “substantially parallel” is a concept that includes being regarded as parallel when taking into consideration an error of approximately 10%. The nozzle substrate 21 is manufactured, for example, by processing a silicon single crystal substrate using semiconductor manufacturing techniques, such as etching, but any known material and manufacturing method may be employed to manufacture the nozzle substrate 21.

The nozzle substrate 21 is formed with the plurality of nozzles N. Here, the nozzle N is a through-hole provided in the nozzle substrate 21. In the present embodiment, it is assumed that the plurality of nozzles N formed in the nozzle substrate 21 include a plurality of nozzles N1 arranged to extend in the Y axis direction and a plurality of nozzles N2 arranged to extend in the Y axis direction at a position in the X2 direction when viewed from the plurality of nozzles N1. Hereinafter, the plurality of nozzles N1 extending in the Y axis direction will be referred to as a nozzle row Ln1, and the plurality of nozzles N2 extending in the Y axis direction will be referred to as a nozzle row Ln2. In addition, hereinafter, the nozzle row In1 and the nozzle row Ln2 may be collectively referred to as a nozzle row Ln.

The communication plate 22 is provided at a position in the Z2 direction when viewed from the nozzle substrate 21, as shown in FIGS. 2 and 3. The communication plate 22 is a plate-like member that is elongated in the Y axis direction and that extends substantially parallel to the XY plane. The communication plate 22 is manufactured, for example, by processing a silicon single crystal substrate using semiconductor manufacturing techniques, but any known material and manufacturing method may be employed to manufacture the communication plate 22.

The communication plate 22 is formed with ink flow paths. Specifically, the communication plate 22 is formed with one supply flow path BA1 provided to extend in the Y axis direction (the Y axis direction is a longitudinal direction) and one supply flow path BA2 provided at a position in the X2 direction when viewed from the supply flow path BA1 to extend in the Y axis direction.

Additionally, the communication plate 22 is formed with a plurality of coupling flow paths BK1, a plurality of coupling flow paths BK2, a plurality of communication flow paths BR1, and a plurality of communication flow paths BR2. Among these, the coupling flow path BK1 communicates with the supply flow path BA1 and is provided at a position in the X2 direction when viewed from the supply flow path BA1 to extend in the Z axis direction (the Z axis direction is a longitudinal direction). The communication flow path BR1 is provided at a position in the X2 direction when viewed from the coupling flow path BK1 to extend in the Z axis direction. The communication flow path BR1 communicates with the nozzle N1 that corresponds to the communication flow path BR1. The coupling flow path BK2 communicates with the supply flow path BA2 and is provided at a position in the X1 direction when viewed from the supply flow path BA2 to extend in the Z axis direction. The communication flow path BR2 is provided at a position in the X1 direction when viewed from the coupling flow path BK2 and in the X2 direction when viewed from the communication flow path BR1 to extend in the Z axis direction. The communication flow path BR2 communicates with the nozzle N2 that corresponds to the communication flow path BR2.

Hereinafter, the supply flow path BAL and the supply flow path BA2 may be collectively referred to as a supply flow path BA. In addition, hereinafter, the coupling flow path BK1 and the coupling flow path BK2 may be collectively referred to as a coupling flow path BK. Further, hereinafter, the communication flow path BR1 and the communication flow path BR2 may be collectively referred to as a communication flow path BR.

The pressure chamber substrate 23 is provided at a position in the Z2 direction when viewed from the communication plate 22, as shown in FIGS. 2 and 3. The pressure chamber substrate 23 is a plate-like member that is elongated in the Y axis direction and that extends substantially parallel to the XY plane. The pressure chamber substrate 23 is manufactured, for example, by processing a silicon single crystal substrate using semiconductor manufacturing techniques, but any known material and manufacturing method may be employed to manufacture the pressure chamber substrate 23.

The pressure chamber substrate 23 is formed with ink flow paths. Specifically, the pressure chamber substrate 23 is formed with a plurality of pressure chambers CV1 that correspond to the plurality of nozzles N1 and a plurality of pressure chambers CV2 that correspond to the plurality of nozzles N2. Among these, when viewed in the Z axis direction, the pressure chamber CV1 joins an end portion of the coupling flow path BK1 in the X2 direction and an end portion of the communication flow path BR1 in the X1 direction and is provided to extend in the X axis direction (the X axis direction is a longitudinal direction). When viewed in the Z axis direction, the pressure chamber CV2 joins an end portion of the coupling flow path BK2 in the X1 direction and an end portion of the communication flow path BR2 in the X2 direction and is provided to extend in the X axis direction. Hereinafter, the pressure chamber CV1 and the pressure chamber CV2 may be collectively referred to as a pressure chamber CV. In addition, the Y axis direction, which is an arrangement direction of the pressure chamber CV, is an example of a “first direction”.

The diaphragm 24 is provided at a position in the Z2 direction when viewed from the pressure chamber substrate 23, as shown in FIGS. 2 and 3. The diaphragm 24 is a plate-like member that is elongated in the Y axis direction and that extends substantially parallel to the XY plane, and is a member capable of elastic vibration. In the present embodiment, among two surfaces of the diaphragm 24 that have the Z axis direction as the normal direction, the surface in the Z2 direction is formed of a non-conductive member. For example, the diaphragm 24 may include an elastic film made of silicon oxide and an insulator film made of zirconium oxide, which is provided at a position in the Z2 direction when viewed from the elastic film.

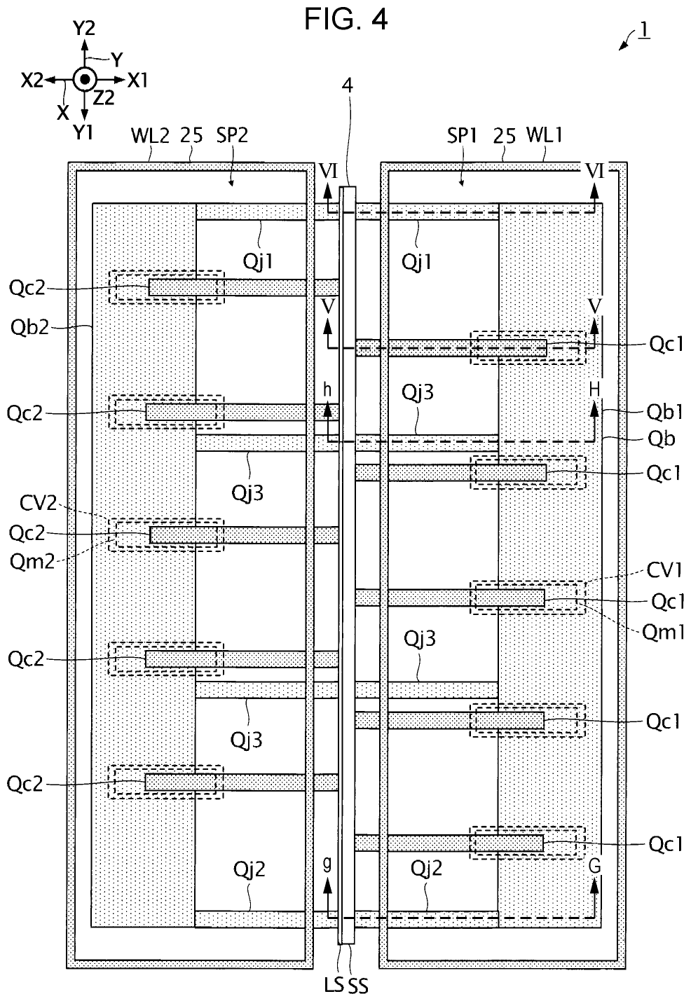

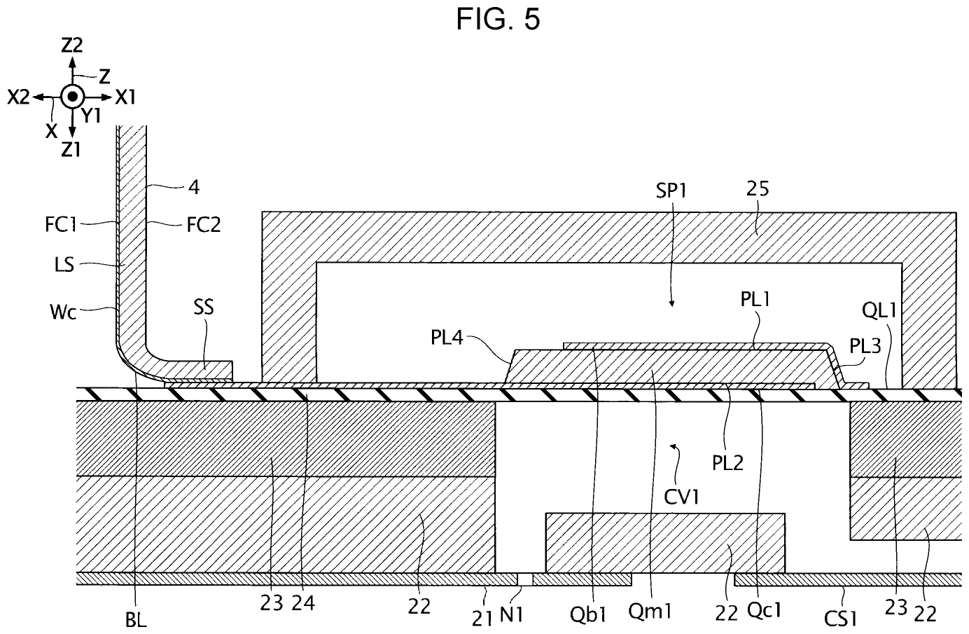

A plurality of piezoelectric elements PZ1 that correspond to the plurality of pressure chambers CV1 and a plurality of piezoelectric elements PZ2 that correspond to the plurality of pressure chambers CV2 are provided at positions in the Z2 direction when viewed from the diaphragm 24, as shown in FIGS. 2 and 3. Hereinafter, the piezoelectric element PZ1 and the piezoelectric element PZ2 may be collectively referred to as a piezoelectric element PZ. The piezoelectric element PZ includes a piezoelectric body Om, an individual electrode Qc individually provided for each of the plurality of pressure chambers CV, and a common electrode Qb provided in common to the plurality of pressure chambers CV. The piezoelectric body Qm, the individual electrode Qc, and the common electrode Qb will be described below with reference to FIGS. 4 and 5. The piezoelectric element PZ is a passive element that is deformed in response to changes in the potential of the drive signal Com. In other words, the piezoelectric element PZ is an example of an energy conversion element that converts electrical energy of the drive signal Com into kinetic energy. Specifically, the piezoelectric element PZ is driven and deformed in response to the changes in the potential of the drive signal Com. The diaphragm 24 vibrates in conjunction with the deformation of the piezoelectric element PZ. When the diaphragm 24 vibrates, the pressure within the pressure chamber CV fluctuates. The fluctuations in pressure within the pressure chamber CV cause the ink, with which the inside of the pressure chamber CV is filled, to be ejected from the nozzle N through the communication flow path BR.

The sealing substrate 25 for protecting the plurality of piezoelectric elements PZ1 and the plurality of piezoelectric elements PZ2 is provided at a position in the Z2 direction when viewed from the pressure chamber substrate 23, as shown in FIGS. 2 and 3. The sealing substrate 25 is a plate-like member that is elongated in the Y axis direction and that extends substantially parallel to the XY plane. The sealing substrate 25 is manufactured, for example, by processing a silicon single crystal substrate using semiconductor manufacturing techniques, but any known material and manufacturing method may be employed to manufacture the sealing substrate 25.

Among two surfaces of the sealing substrate 25 that have the Z axis direction as the normal direction, the surface in the Z1 direction is provided with a recess for covering the plurality of piezoelectric elements PZ1 and a recess for covering the plurality of piezoelectric elements PZ2. Hereinafter, a sealing space that covers the plurality of piezoelectric elements PZ1 and is formed between the diaphragm 24 and the sealing substrate 25 will be referred to as a sealing space SP1, and a sealing space that covers the plurality of piezoelectric elements PZ2 and is formed between the diaphragm 24 and the sealing substrate 25 will be referred to as a sealing space SP2. In addition, hereinafter, the sealing space SP1 and the sealing space SP2 may be collectively referred to as a sealing space SP. The sealing space SP is a space for sealing the piezoelectric element PZ and preventing the piezoelectric element PZ from being deteriorated due to the influence of moisture or the like. Additionally, hereinafter, when the sealing substrate 25 is viewed in plan view in the Z1 direction, a portion that forms a side wall of the sealing space SP1 will be referred to as a side wall WL1, and a portion that forms a side wall of the sealing space SP2 will be referred to as a side wall WL2. Further, hereinafter, the side wall WL1 and the side wall WL2 may be collectively referred to as a side wall WL. The side wall WL is an example of a “wall portion”.

The sealing substrate 25 is provided with a through-hole 250. The through-hole 250 is a hole that, when the sealing substrate 25 is viewed in the Z1 direction, is located between the sealing space SP1 and the sealing space SP2 and penetrates from a surface of the sealing substrate 25 in the Z1 direction to a surface of the sealing substrate 25 in the Z2 direction. The wiring substrate 4 is inserted through the through-hole 250.

The flow path forming substrate 26 is provided at a position in the Z2 direction when viewed from the communication plate 22, as shown in FIGS. 2 and 3. The flow path forming substrate 26 is a plate-like member that is elongated in the Y axis direction and that extends substantially parallel to the XY plane. The flow path forming substrate 26 is formed, for example, by injection molding of a resin material, but any known material and manufacturing method may be employed to manufacture the flow path forming substrate 26.

The flow path forming substrate 26 is formed with ink flow paths. Specifically, the flow path forming substrate 26 is formed with one supply flow path BB1 and one supply flow path BB2. Among these, the supply flow path BB1 communicates with the supply flow path BA1 and is provided at a position in the Z2 direction when viewed from the supply flow path BA1 to extend in the Y axis direction. The supply flow path BB2 communicates with the supply flow path BA2 and is provided at a position in the Z2 direction when viewed from the supply flow path BA2 and in the X2 direction when viewed from the supply flow path BB1 to extend in the Y axis direction. Hereinafter, the supply flow path BB1 and the supply flow path BB2 may be collectively referred to as a supply flow path BB.

The flow path forming substrate 26 is provided with an inlet HL1 that communicates with the supply flow path BB1 and an inlet HL2 that communicates with the supply flow path BB2.

The supply flow path BB1 is supplied with ink from the liquid container 93 through the inlet HL1. The ink supplied to the supply flow path BB1 from the liquid container 93 through the inlet HL1 flows into the supply flow path BA1. The pressure chamber CV1 is filled with a part of the ink that flows into the supply flow path BA1, through the coupling flow path BK1. When the piezoelectric element PZ1 is driven by the drive signal Com, a part of the ink, with which the pressure chamber CV1 is filled, is ejected from the nozzle N1 through the communication flow path BR1. In addition, the supply flow path BB2 is supplied with ink from the liquid container 93 through the inlet HL2. The ink supplied to the supply flow path BB2 from the liquid container 93 through the inlet HL2 flows into the supply flow path BA2. The pressure chamber CV2 is filled with a part of the ink that flows into the supply flow path BA2, through the coupling flow path BK2. When the piezoelectric element PZ2 is driven by the drive signal Com, a part of the ink, with which the pressure chamber CV2 is filled, is ejected from the nozzle N2 through the communication flow path BR2.

The flow path forming substrate 26 is provided with a through-hole 260. The through-hole 260 is a hole that, when the flow path forming substrate 26 is viewed in the Z1 direction, is located between the supply flow path BB1 and the supply flow path BB2 and penetrates from a surface of the flow path forming substrate 26 in the Z1 direction to a surface of the flow path forming substrate 26 in the Z2 direction. The wiring substrate 4 is inserted through the through-hole 260.

The wiring substrate 4 is mounted on the surface of the diaphragm 24 in the Z2 direction, as shown in FIGS. 2 and 3. The wiring substrate 4 is a component for electrically coupling the liquid ejecting head 1 to the control device 7. As the wiring substrate 4, for example, a flexible wiring substrate, such as an FPC or an FFC, is preferably employed. Here, the FPC is an abbreviation for a flexible printed circuit, and the FFC is an abbreviation for a flexible flat cable. An integrated circuit 40 is mounted on the wiring substrate 4. The integrated circuit 40 is an electrical circuit that switches whether or not to supply the drive signal Com to the piezoelectric element PZ, under the control of the control signal SI.

The wiring substrate 4 has an L-shaped cross-section bent along a bending line BL in an XZ plane, as shown in FIG. 3. The wiring substrate 4 includes a first substrate part LS that extends in the Z2 direction from the bending line BL in a YZ plane and a second substrate part SS that extends in the X1 direction from the bending line BL in the XY plane. In addition, the wiring substrate 4 includes a first surface FC1 including a surface of the first substrate part LS in the X2 direction and a surface of the second substrate part SS in the Z1 direction, and a second surface FC2 including a surface of the first substrate part LS in the X1 direction and a surface of the second substrate part SS in the Z2 direction. The second surface FC2 is a back surface of the first surface FC1.

At positions in the Z1 direction when viewed from the communication plate 22, the compliance sheet CS1 is provided to block the supply flow path BAL and the coupling flow path BK1, and the compliance sheet CS2 is provided to block the supply flow path BA2 and the coupling flow path BK2, as shown in FIGS. 2 and 3. Hereinafter, the compliance sheet CS1 and the compliance sheet CS2 may be collectively referred to as a compliance sheet CS. The compliance sheet CS is a plate-like member that is elongated in the Y axis direction and that extends substantially parallel to the XY plane. The compliance sheet CS is formed of an elastic material and absorbs the fluctuations in pressure of the ink in the supply flow path BA and the coupling flow path BK.

### 1-3: Structure of Electrode

FIG. 4 is a plan view of the liquid ejecting head 1 when the liquid ejecting head 1 is viewed in plan view in the Z1 direction. Hereinafter, the structure of the individual electrode Qc and the common electrode Qb in the liquid ejecting head 1 according to the first embodiment will be described with reference to FIG. 4.

The common electrode Qb includes a first common electrode Qb1, a second common electrode Qb2, a first coupling electrode Qj1, a second coupling electrode Qj2, and a plurality of third coupling electrodes Qj3. The individual electrode Qc includes a plurality of first individual electrodes Qc1 and a plurality of second individual electrodes Qc2.

When the liquid ejecting head 1 is viewed in plan view in the Z1 direction, at a position that overlaps the sealing space SP1, which is a space located inside the side wall WL1 of the sealing substrate 25, the plurality of pressure chambers CV1, a plurality of piezoelectric bodies Qm1, the plurality of first individual electrodes Qc1, and the first common electrode Qb1 are provided, as shown in FIG. 4. The plurality of pressure chambers CV1 are provided on a one-to-one basis to correspond to the plurality of nozzles N1. However, one nozzle N1 may be shared by the plurality of pressure chambers CV1, or the plurality of nozzles N1 may be provided in one pressure chamber CV1. Additionally, the plurality of piezoelectric bodies Qm1 are provided on a one-to-one basis to correspond to the plurality of pressure chambers CV1. Further, the plurality of first individual electrodes Qc1 are provided on a one-to-one basis to correspond to the plurality of pressure chambers CV1. The first common electrode Qb1 is provided in common to the plurality of pressure chambers CV1. More specifically, the first common electrode Qb1 is provided to overlap the plurality of pressure chambers CV1 when the liquid ejecting head 1 is viewed in plan view in the Z1 direction. However, the first common electrode Qb1 may be provided such that each of the plurality of pressure chambers CV1 includes a portion that does not overlap the first common electrode Qb1 when the liquid ejecting head 1 is viewed in plan view in the Z1 direction. The sealing substrate 25 is provided to overlap the plurality of pressure chambers CV1 when viewed in the Z axis direction.

Similarly, when the liquid ejecting head 1 is viewed in plan view in the Z1 direction, at a position that overlaps the sealing space SP2, which is a space located inside the side wall WL2 of the sealing substrate 25, the plurality of pressure chambers CV2, a plurality of piezoelectric bodies Qm2, the plurality of second individual electrodes Qc2, and the second common electrode Qb2 are provided. The plurality of pressure chambers CV2 are provided on a one-to-one basis to correspond to the plurality of nozzles N2. However, one nozzle N2 may be shared by the plurality of pressure chambers CV2, or a plurality of nozzles N2 may be provided in one pressure chamber CV2. In addition, the plurality of piezoelectric bodies Qm2 are provided on a one-to-one basis to correspond to the plurality of pressure chambers CV2. Further, the plurality of second individual electrodes Qc2 are provided on a one-to-one basis to correspond to the plurality of pressure chambers CV2. The second common electrode Qb2 is provided in common to the plurality of pressure chambers CV2. More specifically, the second common electrode Qb2 is provided to overlap the plurality of pressure chambers CV2 when the liquid ejecting head 1 is viewed in plan view in the Z1 direction. However, the second common electrode Qb2 may be provided such that each of the plurality of pressure chambers CV2 includes a portion that does not overlap the second common electrode Qb2 when the liquid ejecting head 1 is viewed in plan view in the Z1 direction. The sealing substrate 25 is provided to overlap the plurality of pressure chambers CV2 when viewed in the Z axis direction.

The first coupling electrode Qj1 electrically couples the first common electrode Qb1 and a first common wiring line Wb1, which will be described below, provided on the wiring substrate 4. Additionally, the first coupling electrode Qj1 electrically couples the first common wiring line Wb1 and the second common electrode Qb2. The first common wiring line Wb1 is set to a reference potential VBS. As a result, the first common electrode Qb1 and the second common electrode Qb2 are also set to the reference potential VBS. In addition, the first coupling electrode Qj1 electrically couples the first common electrode Qb1 and the second common electrode Qb2 at end portions of the first common electrode Qb1 and the second common electrode Qb2 in the Y2 direction of the Y axis direction.

The second coupling electrode Qj2 electrically couples the first common electrode Qb1 and a second common wiring line Wb2, which will be described below, provided on the wiring substrate 4. Further, the second coupling electrode Qj2 electrically couples the second common wiring line Wb2 and the second common electrode Qb2. The second common wiring line Wb2 is set to the reference potential VBS. As a result, the first common electrode Qb1 and the second common electrode Qb2 are also set to the reference potential VBS. In addition, the second coupling electrode Qj2 electrically couples the first common electrode Qb1 and the second common electrode Qb2 at end portions of the first common electrode Qb1 and the second common electrode Qb2 in the Y1 direction of the Y axis direction.

As described above, since the common electrode Qb includes the first common electrode Qb1, the second common electrode Qb2, the first coupling electrode Qj1, and the second coupling electrode Qj2, the common electrode Qb is set to the reference potential VBS as a whole.

In the above embodiment, the common electrode Qb includes one first coupling electrode Qj1, and the one first coupling electrode Qj1 electrically couples the first common electrode Qb1 and the second common electrode Qb2. However, as another aspect, the common electrode Qb may include two first coupling electrodes Qj1, that is, the first coupling electrode Qj1 for electrically coupling the first common electrode Qb1 and the first common wiring line Wb1 and the first coupling electrode Qj1 for electrically coupling the second common electrode Qb2 and the first common wiring line Wb1. In this case, the first common wiring line Wb1 is electrically coupled to each of the two first coupling electrodes Qj1 individually.

Similarly, in the above embodiment, the common electrode Qb includes one second coupling electrode Qj2, and the one second coupling electrode Qj2 electrically couples the first common electrode Qb1 and the second common electrode Qb2. However, as another aspect, the common electrode Qb may include two second coupling electrodes Qj2, that is, the second coupling electrode Qj2 for electrically coupling the first common electrode Qb1 and the second common wiring line Wb2 and the second coupling electrode Qj2 for electrically coupling the second common electrode Qb2 and the second common wiring line Wb2. In this case, the second common wiring line Wb2 is electrically coupled to each of the two second coupling electrodes Qj2 individually.

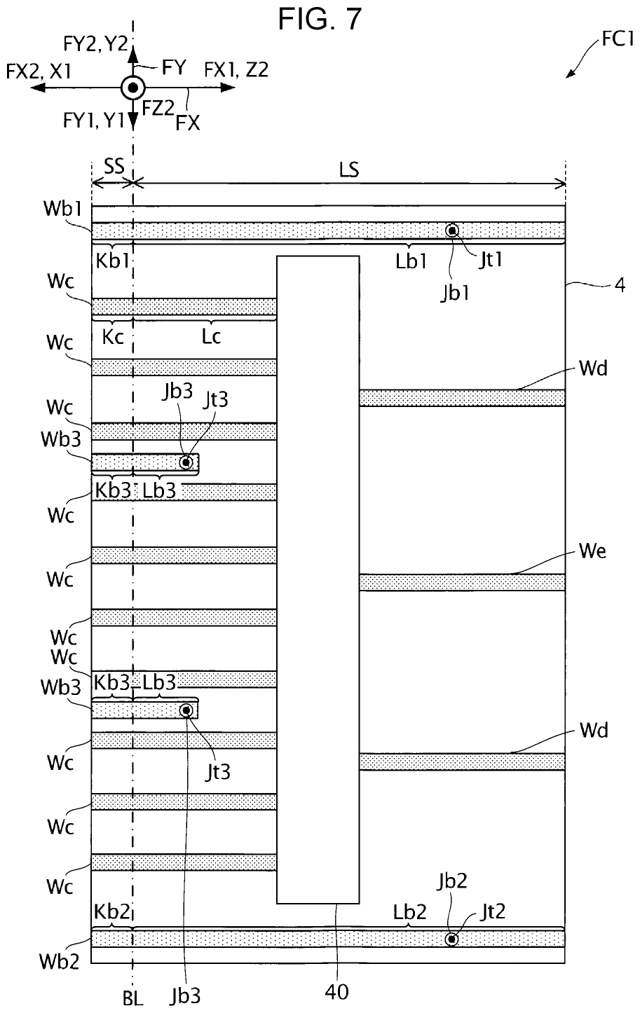

The first common wiring line Wb1 and the second common wiring line Wb2 will be described below with reference to FIG. 7.

In addition, the third coupling electrode Qj3 electrically couples the first common electrode Qb1 and a third common wiring line Wb3, which will be described below, provided on the wiring substrate 4. Further, the third coupling electrode Qj3 electrically couples the third common wiring line Wb3 and the second common electrode Qb2. The third coupling electrode Qj3 electrically couples the first common electrode Qb1 and the second common electrode Qb2, between the first coupling electrode Qj1 and the second coupling electrode Qj2 in the Y axis direction. The third common wiring line Wb3 will be described below with reference to FIG. 7.

In the present embodiment, it is assumed that the plurality of third coupling electrodes Qj3 are provided between the first coupling electrode Qj1 and the second coupling electrode Qj2. However, the present disclosure is not limited to such an aspect. One third coupling electrode Qj3 may be provided between the first coupling electrode Qj1 and the second coupling electrode Qj2.

The common electrode Qb is formed of a conductive material. Specifically, as the material of the common electrode Qb, for example, metals, such as platinum, iridium, gold, or titanium, or conductive materials, such as a conductive metal oxide including indium tin oxide abbreviated as ITO, can be employed.

The piezoelectric body Qm1 is provided to overlap the pressure chamber CV1 when the liquid ejecting head 1 is viewed in plan view in the Z1 direction. However, when the liquid ejecting head 1 is viewed in plan view in the Z1 direction, a part of the pressure chamber CV1 may be provided not to overlap the piezoelectric body Qm1. In the example shown in FIG. 4, the piezoelectric body Qm1 is provided such that the entire piezoelectric body Qm1 is included in the pressure chamber CV1 corresponding to the piezoelectric body Qm1 when the liquid ejecting head 1 is viewed in plan view in the Z1 direction.

The relationship between the piezoelectric body Qm2 and the pressure chamber CV2 is the same as the relationship between the piezoelectric body Qm1 and the pressure chamber CV1.

The piezoelectric body Qm1 and the piezoelectric body Qm2 are formed of, for example, a crystal film having a perovskite structure made of a ferroelectric ceramic material exhibiting electromechanical conversion properties, that is, a so-called perovskite type crystal. Specifically, as the materials of the piezoelectric body Qm1 and the piezoelectric body Qm2, for example, a ferroelectric piezoelectric material, such as lead zirconate titanate, a material obtained by adding a metal oxide, such as niobium oxide, nickel oxide, or magnesium oxide, to the ferroelectric piezoelectric material, such as lead zirconate titanate, or the like can be employed. More specifically, as the materials of the piezoelectric body Qm1 and the piezoelectric body Qm2, for example, lead titanate, lead zirconate titanate, lead zirconate, lead lanthanum titanate, lead lanthanum zirconate titanate, magnesium niobate-lead zirconate titanate, or the like can be employed.

As described above, the plurality of first individual electrodes Qc1 are provided on the liquid ejecting head 1 on a one-to-one basis to correspond to the plurality of pressure chambers CV1. Each first individual electrode Qc1 is coupled to an individual wiring line Wc provided on the wiring substrate 4. The individual wiring line Wc is supplied with the drive signal Com from the control device 7. As a result, each first individual electrode Qc1 is supplied with the drive signal Com. The individual wiring line Wc will be described below with reference to FIG. 7.

Similarly, the plurality of second individual electrodes Qc2 are provided on the liquid ejecting head 1 on a one-to-one basis to correspond to the plurality of pressure chambers CV2. Each second individual electrode Qc2 is coupled to the individual wiring line Wc provided on the wiring substrate 4. As described above, the individual wiring line Wc is supplied with the drive signal Com from the control device 7. As a result, each second individual electrode Qc2 is supplied with the drive signal Com.

In addition, the individual electrode Qc is formed of a conductive material. Specifically, as the material of the individual electrode Qc, for example, metals, such as platinum, iridium, gold, or titanium, or conductive materials, such as a conductive metal oxide including indium tin oxide abbreviated as ITO, can be employed.

In FIG. 4, for convenience of description, in the Y axis direction, a Y2-side end portion of the wiring substrate 4 is located in the Y2 direction with respect to Y2-side end portions of the first common electrode Qb1 and the second common electrode Qb2. However, in the Y axis direction, the Y2-side end portion of the wiring substrate 4 may be at the same position as the Y2-side end portions of the first common electrode Qb1 and the second common electrode Qb2 or may be located in the Y1 direction with respect to the Y2-side end portions of the first common electrode Qb1 and the second common electrode Qb2.

Similarly, in FIG. 4, in the Y axis direction, a Y1-side end portion of the wiring substrate 4 is located in the Y1 direction with respect to Y1-side end portions of the first common electrode Qb1 and the second common electrode Qb2. However, the Y1-side end portion of the wiring substrate 4 may be at the same position as the Y1-side end portions of the first common electrode Qb1 and the second common electrode Qb2 or may be located in the Y2 direction with respect to the Y1-side end portions of the first common electrode Qb1 and the second common electrode Qb2.

In addition, in FIG. 4, the first coupling electrode Qj1, the second coupling electrode Qj2, and the third coupling electrode Qj3 have linear shapes extending in the X axis direction, but in the above case, at least one of these electrodes may be obliquely disposed with respect to the X axis direction or may have a bent shape in the XY plane.

### 1-4: Configuration Near First Individual Electrode Qc1

FIG. 5 is a cross-sectional view taken along line V-V in FIG. 4.

Among the two surfaces of the diaphragm 24 that have the Z axis direction as the normal direction, at the surface in the Z2 direction, the first common electrode Qb1, the first individual electrode Qc1, the piezoelectric body Qm1, and the sealing substrate 25 are formed, as shown in FIG. 5.

Hereinafter, among two surfaces of the piezoelectric body Qm1 that have the Z axis direction as the normal direction, the surface in the Z2 direction will be referred to as a surface PL1. Additionally, among the two surfaces of the piezoelectric body Qm1 that have the Z axis direction as the normal direction, the surface in the Z1 direction will be referred to as a surface PL2. Further, among inclined surfaces of the piezoelectric body Qm1, the surface in the X1 direction will be referred to as a surface PL3, and the surface in the X2 direction will be referred to as a surface PL4. Furthermore, among the two surfaces of the diaphragm 24 that have the Z axis direction as the normal direction, the surface in the Z2 direction will be referred to as a surface QL1.

The first common electrode Qb1 is formed at the surface PL1 and the surface PL3 of the piezoelectric body Qm1 and the surface QL1 of the diaphragm 24. In other words, the first common electrode Qb1 is installed on the surface PL1 on a side opposite to the pressure chamber CV1, among the surfaces of the piezoelectric body Qm1. An end portion of the first common electrode Qb1 in the X2 direction is on the surface PL1 and is located in the X1 direction with respect to the surface PL4. In addition, an end portion of the first common electrode Qb1 in the X1 direction is on the surface QL1 and is located inside the sealing substrate 25.

The first individual electrode Qc1 is formed at the surface PL2 of the piezoelectric body Qm1. In other words, the first individual electrode Qc1 is installed on the surface PL2 on a pressure chamber CV1 side among the surfaces of the piezoelectric body Qm1. An end portion of the first individual electrode Qc1 in the X1 direction is located in the X2 direction with respect to the surface PL3. Additionally, the first individual electrode Qc1 extends to the outside of the sealing substrate 25 in the X2 direction. The first individual electrode Qc1 is coupled to the individual wiring line Wc provided on the first surface FC1 of the wiring substrate 4, on the outside of the sealing substrate 25.

### 1-5: Configuration Near First Coupling Electrode Qj1

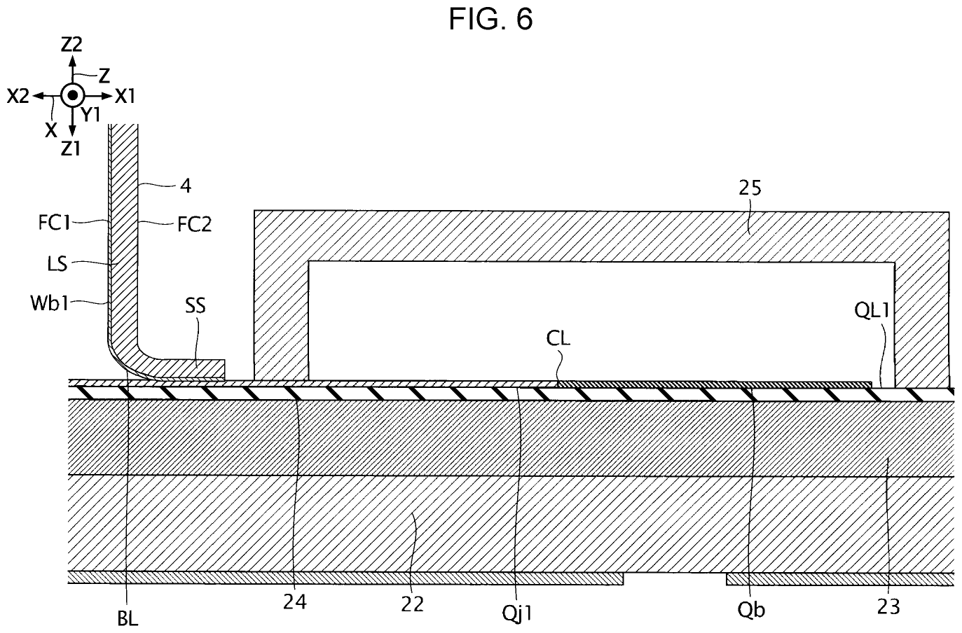

FIG. 6 is a cross-sectional view taken along line VI-VI in FIG. 4.

The first coupling electrode Qj1 and the common electrode Qb are formed at the surface QL1 of the diaphragm 24, as shown in FIG. 6. The first coupling electrode Qj1 and the common electrode Qb are coupled to each other on a coupling line CL shown in FIG. 6. An end portion of the common electrode Qb in the X1 direction is on the surface QL1 and is located inside the sealing substrate 25. The first coupling electrode Qj1 extends to the outside of the sealing substrate 25 in the X2 direction. The first coupling electrode Qj1 is coupled to the first common wiring line Wb1 provided on the first surface FC1 of the wiring substrate 4, on the outside of the sealing substrate 25.

In the cross-section taken along line g-G in FIG. 4, the second coupling electrode Qj2 is electrically coupled to the second common wiring line Wb2 provided on the first surface FC1 in the second substrate part SS. Since the configuration is the same as that in the cross-section taken along line VI-VI shown in FIG. 6 except that the first coupling electrode Qj1 is replaced with the second coupling electrode Qj2 and the first common wiring line Wb1 is replaced with the second common wiring line Wb2, the illustration thereof will not be repeated.

In addition, in the cross-section taken along line h-H in FIG. 4, the third coupling electrode Qj3 is electrically coupled to the third common wiring line Wb3 provided on the first surface FC1 in the second substrate part SS. Since the configuration is the same as that in the cross-section taken along line VI-VI shown in FIG. 6 except that the first coupling electrode Qj1 is replaced with the third coupling electrode Qj3 and the first common wiring line Wb1 is replaced with the third common wiring line Wb3, the illustration thereof will not be repeated.

### 1-6: Configuration of Wiring Substrate 4

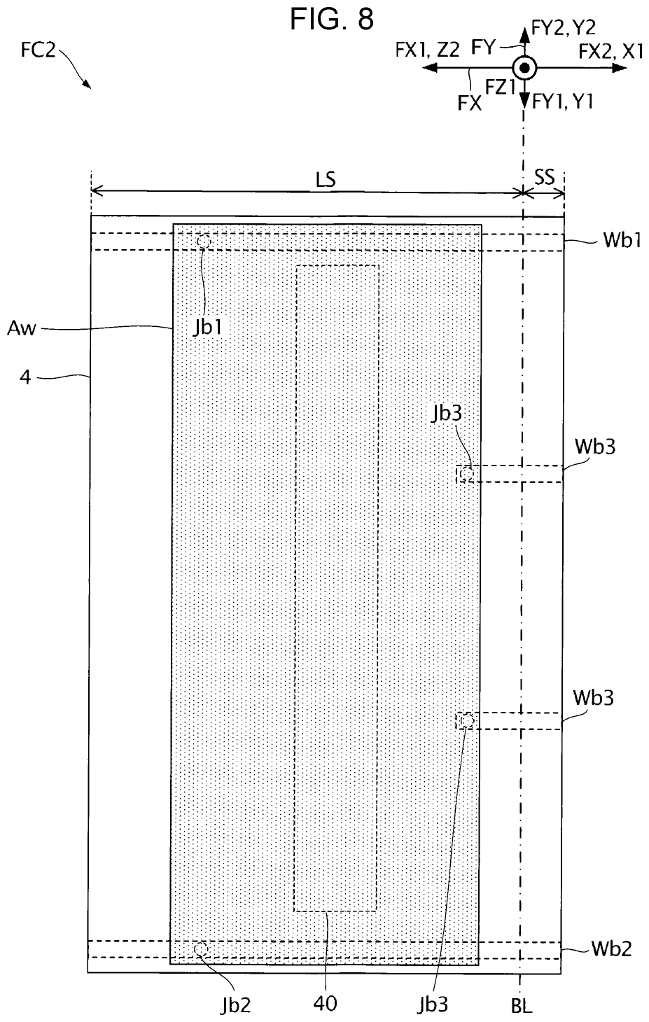

FIGS. 7 and 8 are explanatory diagrams illustrating various wiring lines provided on the wiring substrate 4. Hereinafter, among extension directions of various wiring lines on the wiring substrate 4, a direction from the piezoelectric element PZ toward the control device 7 will be referred to as an FX1 direction, and a direction opposite to the FX1 direction will be referred to as an FX2 direction. The FX1 direction and the FX2 direction will be referred to as an FX direction. In the first substrate part LS on an FX1 side with respect to the bending line BL, the FX1 direction coincides with the Z2 direction. Meanwhile, in the second substrate part SS on an FX2 side with respect to the bending line BL, the FX2 direction coincides with the X1 direction.

In addition, hereinafter, in the wiring substrate 4, a direction from the first surface FC1 to the second surface FC2 will be referred to as an FZ1 direction, and a direction opposite to the FZ1 direction will be referred to as an FZ2 direction. The FZ1 direction and the FZ2 direction will be referred to as an FZ direction. In the first substrate part LS on the FX1 side with respect to the bending line BL, the FZ1 direction coincides with the X1 direction, and the FZ2 direction coincides with the X2 direction. In the second substrate part SS on the FX2 side with respect to the bending line BL, the FZ1 direction coincides with the Z2 direction, and the FZ2 direction coincides with the Z1 direction. In addition, hereinafter, in the wiring substrate 4, a direction orthogonal to both the FX direction and the FZ direction will be referred to as an FY direction. In the FY direction, a direction that coincides with the Y1 direction will be referred to as an FY1 direction, and a direction that is opposite to the FY1 direction and coincides with the Y2 direction will be referred to as an FY2 direction.

FIG. 7 is a configuration diagram of the wiring substrate 4 illustrating the arrangement of the wiring lines and electronic components provided on the first surface FC1 when the first surface FC1 of the wiring substrate 4 is viewed from an FZ2 side toward an FZ1 side.

FIG. 8 is a configuration diagram of the wiring substrate 4 illustrating the arrangement of the wiring lines provided on the second surface FC2 when the second surface FC2 of the wiring substrate 4 is viewed from the FZ1 side toward the FZ2 side. In FIG. 8, for convenience of description, a part of the wiring lines and electronic components provided on the first surface FC1 is shown by dashed lines.

As shown in FIG. 7, the first common wiring line Wb1, the second common wiring line Wb2, and a plurality of the third common wiring lines Wb3 are installed on the first surface FC1 of the wiring substrate 4. In the Y axis direction, the plurality of third common wiring lines Wb3 are installed between the first common wiring line Wb1 and the second common wiring line Wb2. As will be described below, the first common wiring line Wb1 is electrically coupled to the first coupling electrode Qj1. The second common wiring line Wb2 is electrically coupled to the second coupling electrode Qj2. The plurality of third common wiring lines Wb3 are provided on a one-to-one basis to correspond to the plurality of third coupling electrodes Qj3. Each third common wiring line Wb3 is coupled to the third coupling electrode Qj3 that corresponds to the third common wiring line Wb3. In addition, hereinafter, the wiring lines including the first common wiring line Wb1, the second common wiring line Wb2, and the third common wiring line Wb3 described above may be referred to as a common wiring line Wb.

In the present embodiment, as described above, it is assumed that the plurality of third common wiring lines Wb3 are provided between the first common wiring line Wb1 and the second common wiring line Wb2. However, the present disclosure is not limited to such an aspect. One third common wiring line Wb3 may be provided between the first common wiring line Wb1 and the second common wiring line Wb2.

The first common wiring line Wb1 includes a first common wiring line coupling portion Kb1 installed on the first surface FC1 in the second substrate part SS and a first common wiring line extension portion Lb1 installed on the first surface FC1 in the first substrate part LS.

The first common wiring line extension portion Lb1 is electrically coupled to a power supply circuit (not shown) of the control device 7 and is supplied with the reference potential VBS from the power supply circuit. Therefore, the first common wiring line Wb1 including the first common wiring line extension portion Lb1 is set to the reference potential VBS. In addition, the first common wiring line coupling portion Kb1 provided in the first common wiring line Wb1 is coupled to the first coupling electrode Qj1. Therefore, the first common electrode Qb1 is also set to the reference potential VBS.

The second common wiring line Wb2 includes a second common wiring line coupling portion Kb2 installed on the first surface FC1 in the second substrate part SS and a second common wiring line extension portion Lb2 installed on the first surface FC1 in the first substrate part LS.

The second common wiring line extension portion Lb2 is electrically coupled to the power supply circuit (not shown) of the control device 7 and is supplied with the reference potential VBS from the power supply circuit. Therefore, the second common wiring line Wb2 including the second common wiring line extension portion Lb2 is set to the reference potential VBS. Additionally, the second common wiring line coupling portion Kb2 provided in the second common wiring line Wb2 is coupled to the second coupling electrode Qj2. Therefore, the second common electrode Qb2 is also set to the reference potential VBS.

The third common wiring line Wb3 includes a third common wiring line coupling portion Kb3 installed on the first surface FC1 in the second substrate part SS and a third common wiring line extension portion Lb3 installed on the first surface FC1 in the first substrate part LS. The third common wiring line coupling portion Kb3 provided in the third common wiring line Wb3 is coupled to the third coupling electrode Qj3. An FX1-side end portion of the third common wiring line extension portion Lb3 is located on the FX2 side with respect to the integrated circuit 40, on the first surface FC1 in the first substrate part LS.

In addition, a plurality of the individual wiring lines Wc, one or more first supply wiring lines Wd, and one or more second supply wiring lines We are further installed on the first surface FC1 of the wiring substrate 4. In the present embodiment, as an example, it is assumed that two first supply wiring lines Wd and one second supply wiring line We are disposed on the first surface FC1 of the wiring substrate 4.

The individual wiring line Wc includes an individual wiring line coupling portion Kc installed on the first surface FC1 in the second substrate part SS and an individual wiring line extension portion Lc installed on the first surface FC1 in the first substrate part LS.

The individual wiring line extension portion Lc is coupled to the integrated circuit 40.

The plurality of individual wiring lines Wc are provided on a one-to-one basis to correspond to the plurality of individual electrodes Qc. The individual wiring line coupling portion Kc is coupled to the individual electrode Qc provided to correspond to the individual wiring line Wc including the individual wiring line coupling portion Kc among the plurality of individual electrodes Qc.

The one or more first supply wiring lines Wd are coupled to the integrated circuit 40 in the first substrate part LS. Additionally, the one or more first supply wiring lines Wd are coupled to the control device 7 at an FX1-side end portion. The integrated circuit 40 is supplied with the drive signal Com from the control device 7 through the one or more first supply wiring lines Wd.

The one or more second supply wiring lines We are coupled to the integrated circuit 40 in the first substrate part LS. In addition, the one or more second supply wiring lines We are coupled to the control device 7 an FX1-side end portion. The integrated circuit 40 is supplied with the control signal SI from the control device 7 through the one or more second supply wiring lines We.

The integrated circuit 40 switches whether or not to supply the drive signal Com to the individual wiring line Wc based on the control signal SI. When the integrated circuit 40 supplies the drive signal Com to the individual wiring line Wc, the individual wiring line Wc supplies the drive signal Com to the individual electrode Qc. In other words, the individual wiring line Wc applies a voltage to the individual electrode Qc.

On the first surface FC1 of the wiring substrate 4 shown in FIG. 7, the first common wiring line Wb1 is coupled to the first coupling electrode Qj1 on an FY2 side, which is one side along the FY direction, with respect to coupling positions between the plurality of individual electrodes Qc and the plurality of individual wiring lines Wc. In addition, on the first surface FC1, the second common wiring line Wb2 is coupled to the second coupling electrode Qj2 on an FY1 side, which is another side along the FY direction, with respect to the coupling positions between the plurality of individual electrodes Qc and the plurality of individual wiring lines Wc. In FIG. 7, for convenience of description, each of the first common wiring line Wb1, the second common wiring line Wb2, and the plurality of individual wiring lines Wc has a linear shape extending in the FX direction, but at least one of these wiring lines may be obliquely disposed with respect to the FX direction and may have a bent shape in the first surface FC1.

In FIG. 8, an auxiliary wiring line Aw is installed on the second surface FC2 of the wiring substrate 4. In more detail, the auxiliary wiring line Aw is installed on the second surface FC2 in the first substrate part LS of the wiring substrate 4. As will be described below, the auxiliary wiring line Aw is installed to reduce the resistance of the common electrode Qb.

When the wiring substrate 4 is viewed in plan view in the FZ direction, the auxiliary wiring line Aw and the integrated circuit 40 are installed at positions that overlap each other. In addition, when the wiring substrate 4 is viewed in plan view in the FZ direction, the auxiliary wiring line Aw, a part of the first common wiring line Wb1, a part of the second common wiring line Wb2, and a part of the third common wiring line Wb3 are installed at positions that overlap each other. Further, in the first substrate part LS, the cross-sectional area of the auxiliary wiring line Aw orthogonal to the FX direction is larger than the cross-sectional area of the individual wiring line Wc orthogonal to the FX direction. The auxiliary wiring line Aw is not electrically coupled to the individual wiring line Wc.

A first through-hole Jb1, a second through-hole Jb2, and a plurality of third through-holes Jb3 are installed in the wiring substrate 4. The plurality of third through-holes Jb3 are provided on a one-to-one basis to correspond to the plurality of third common wiring lines Wb3. Hereinafter, the first through-hole Jb1, the second through-hole Jb2, and the third through-hole Jb3 may be collectively referred to as a through-hole Jb.

When the wiring substrate 4 is viewed in plan view in the FZ direction, the first through-hole Jb1 is installed at a position that overlaps the first common wiring line extension portion Lb1 provided in the first common wiring line Wb1. The first common wiring line Wb1 is electrically coupled to the auxiliary wiring line Aw through a conductor penetrating through the first through-hole Jb1 at a first coupling point Jt1 which is located at a position that overlaps the first through-hole Jb1 when viewed in the FZ direction. As described above, the first common wiring line Wb1 is coupled to the common electrode Qb. Therefore, the first common wiring line Wb1 electrically couples the auxiliary wiring line Aw and the common electrode Qb.

When the wiring substrate 4 is viewed in plan view in the FZ direction, the second through-hole Jb2 is installed at a position that overlaps the second common wiring line extension portion Lb2 provided in the second common wiring line Wb2. The second common wiring line Wb2 is electrically coupled to the auxiliary wiring line Aw through a conductor penetrating through the second through-hole Jb2 at a second coupling point Jt2 which is located at a position that overlaps the second through-hole Jb2 when viewed in the FZ direction. As described above, the second common wiring line Wb2 is coupled to the common electrode Qb. Therefore, the second common wiring line Wb2 electrically couples the auxiliary wiring line Aw and the common electrode Qb.

As a result, the auxiliary wiring line Aw electrically couples the first common wiring line Wb1 and the second common wiring line Wb2.

The third through-hole Jb3 is installed at a position that overlaps an end portion of the third common wiring line Wb3 when the wiring substrate 4 is viewed in plan view in the FZ direction. The third common wiring line Wb3 is electrically coupled to the auxiliary wiring line Aw through a conductor penetrating through the third through-hole Jb3 at a third coupling point Jt3 which is located at a position that overlaps the third through-hole Jb3 when viewed in the FZ direction. As described above, since the third common wiring line coupling portion Kb3 provided in the third common wiring line Wb3 is coupled to the third coupling electrode Qj3, the third common wiring line Wb3 electrically couples the common electrode Qb and the auxiliary wiring line Aw.

Hereinafter, the first coupling point Jt1, the second coupling point Jt2, and the third coupling point Jt3 may be collectively referred to as a coupling point Jt.

The materials of the common wiring line Wb, the individual wiring line Wc, the first supply wiring line Wd, the second supply wiring line We, and the auxiliary wiring line Aw are appropriately selected from gold, copper, aluminum, and the like.

As described above, according to the related art, since the structure is provided in which the auxiliary electrode is stacked on the common electrode Qb provided in the liquid ejecting head, there is an issue of increasing the thickness of the liquid ejecting head as compared with the aspect in which the liquid ejecting head is not provided with the auxiliary electrode.

On the other hand, with the liquid ejecting head 1 according to the present embodiment, the auxiliary wiring line Aw is provided on the wiring substrate 4 existing outside the sealing substrate 25, instead of stacking the auxiliary electrode on the common electrode Qb, thereby eliminating the need to increase the thickness of the liquid ejecting head 1.

As another issue, when the common electrode Qb has high resistance, there is a tendency for an increase in the occurrence of electric crosstalk as compared with when the common electrode Qb has low resistance. Specifically, when the common electrode Qb has high resistance, the potential of the common electrode Qb is more susceptible to the influence of the fluctuations in the potential of the drive signal Com supplied to the individual electrode Qc as compared with when the common electrode Qb has low resistance. When the potential of the common electrode Qb fluctuates, the voltage applied between the common electrode Qb and the individual electrode Qc that constitute the piezoelectric element PZ fluctuates from the desired voltage, which may lead to deterioration of the printing quality.

In the liquid ejecting head 1 according to the present embodiment, by providing the auxiliary wiring line Aw on the wiring substrate 4, the resistance of the common electrode Qb can be reduced without increasing the thickness of the liquid ejecting head 1. As a result, the liquid ejecting head 1 according to the present embodiment can suppress the deterioration of the printing quality.

In addition, when a wiring line such as the auxiliary electrode is provided near the piezoelectric element PZ, the reliability and characteristics of the piezoelectric element PZ may be adversely affected by the plating used for the wiring line. In the liquid ejecting head 1 according to the present embodiment, since the wiring line such as the auxiliary electrode is not provided near the piezoelectric element PZ, the adverse effect can be suppressed.

### 1-7: Effect of First Embodiment

The liquid ejecting head 1 according to the present embodiment includes the nozzle substrate 21, the pressure chamber substrate 23, the piezoelectric element PZ, and the wiring substrate 4. The nozzle substrate 21 is provided with the nozzle N for ejecting ink. The pressure chamber substrate 23 is provided with the plurality of pressure chambers CV for applying pressure to the ink. The piezoelectric element PZ includes the piezoelectric body Qm, the individual electrode Qc individually provided for each of the plurality of pressure chambers CV, and the common electrode Qb provided in common to the plurality of pressure chambers CV. The wiring substrate 4 is provided with the individual wiring line Wc for applying a voltage to the individual electrode Qc, the common wiring line Wb for applying a voltage to the common electrode Qb, and the auxiliary wiring line Aw that is electrically coupled to the common wiring line Wb to reduce the resistance of the common electrode Qb.

With the liquid ejecting head 1 having the above configuration, by providing the auxiliary wiring line Aw on the wiring substrate 4, instead of stacking the auxiliary electrode on the common electrode Qb, the resistance of the common electrode Qb can be reduced without increasing the thickness of the liquid ejecting head 1.

In addition, in the liquid ejecting head 1 according to the present embodiment, the individual wiring line Wc and the common wiring line Wb are provided on the first surface FC1 of the wiring substrate 4. The auxiliary wiring line Aw is provided on the second surface FC2 on the back of the first surface FC1 of the wiring substrate 4.

With the liquid ejecting head 1 having the above configuration, the size of the wiring substrate 4 can be reduced as compared with a structure in which the individual wiring line Wc, the common wiring line Wb, and the auxiliary wiring line Aw are provided on the same surface of the wiring substrate 4.

Further, in the liquid ejecting head 1 according to the present embodiment, the common wiring line Wb and the auxiliary wiring line Aw are electrically coupled through the through-hole Jb installed in the wiring substrate 4.

With the liquid ejecting head 1 having the above configuration, the common wiring line Wb and the auxiliary wiring line Aw can be provided on different surfaces of the wiring substrate 4 from each other, thereby reducing the size of the wiring substrate 4.

Additionally, in the liquid ejecting head 1 according to the present embodiment, the wiring substrate 4 is further provided with the integrated circuit 40 to which the individual wiring line Wc is coupled. When the wiring substrate 4 is viewed in plan view, the auxiliary wiring line Aw and the integrated circuit 40 are installed at positions that overlap each other.

With the liquid ejecting head 1 having the above configuration, the auxiliary wiring line Aw and the integrated circuit 40 are installed at positions that overlap each other, thereby providing a shielding effect.

Further, in the liquid ejecting head 1 according to the present embodiment, the common wiring line Wb includes the first common wiring line Wb1 and the second common wiring line Wb2. The auxiliary wiring line Aw electrically couples the first common wiring line Wb1 and the second common wiring line Wb2.

With the liquid ejecting head 1 having the above configuration, noise occurring in the integrated circuit 40 is suppressed.

In addition, in the liquid ejecting head 1 according to the present embodiment, when the arrangement direction of the plurality of pressure chambers CV is the first direction, the first common wiring line Wb1 is coupled to the common electrode Qb on one side along the first direction with respect to the coupling position between the individual electrode Qc and the individual wiring line Wc. The second common wiring line Wb2 is coupled to the common electrode Qb on another side along the first direction with respect to the coupling position between the individual electrode Qc and the individual wiring line Wc.

With the liquid ejecting head 1 having the above configuration, noise occurring in the integrated circuit 40 is suppressed.

Additionally, the liquid ejecting head 1 according to the present embodiment further includes the third common wiring line Wb3 that is installed between the first common wiring line Wb1 and the second common wiring line Wb2 in the first direction, which is the arrangement direction of the plurality of pressure chambers CV, and that electrically couples the common electrode Qb and the auxiliary wiring line Aw.

With the liquid ejecting head 1 having the above configuration, voltage drop occurring near the center of the arrangement direction of the plurality of pressure chambers CV is suppressed in the common electrode Qb.

Further, in the liquid ejecting head 1 according to the present embodiment, the first common wiring line Wb1 is electrically coupled to the auxiliary wiring line Aw at the first coupling point Jt1 located in the middle of the first common wiring line Wb1. The third common wiring line Wb3 is electrically coupled to the auxiliary wiring line Aw at one end of the third common wiring line Wb3.

With the liquid ejecting head 1 having the above configuration, voltage drop occurring near the center of the arrangement direction of the plurality of pressure chambers CV is suppressed in the common electrode Qb.

Moreover, in the liquid ejecting head 1 according to the present embodiment, the cross-sectional area of the auxiliary wiring line Aw is larger than the cross-sectional area of the individual wiring line Wc.

By increasing the cross-sectional area of the auxiliary wiring line Aw, the resistance of the common electrode Qb can be further reduced.

In addition, in the liquid ejecting head 1 according to the present embodiment, the common electrode Qb is installed on the surface of the piezoelectric body Om opposite to the surface of the piezoelectric body on the pressure chamber CV side. The individual electrode Qc is installed on the surface of the piezoelectric body Om on the pressure chamber CV side.

The piezoelectric element PZ can be deformed by installing the common electrode Qb and the individual electrode Qc on the opposite surfaces of the piezoelectric body Qm. Consequently, the diaphragm 24 vibrates due to the deformation of the piezoelectric element PZ, so that the pressure in the pressure chamber CV fluctuates, and the ink, with which the inside of the pressure chamber CV is filled, is ejected from the nozzle N.

Further, the liquid ejecting apparatus 100 according to the present embodiment includes the liquid ejecting head 1 and the control device 7 that controls the ejection operation of the liquid from the liquid ejecting head 1.

With the liquid ejecting apparatus 100 having the above configuration, by providing the auxiliary wiring line Aw on the wiring substrate 4, instead of stacking the auxiliary electrode on the common electrode Qb, the resistance of the common electrode Qb can be reduced without increasing the thickness of the liquid ejecting head 1.

### 2: Second Embodiment

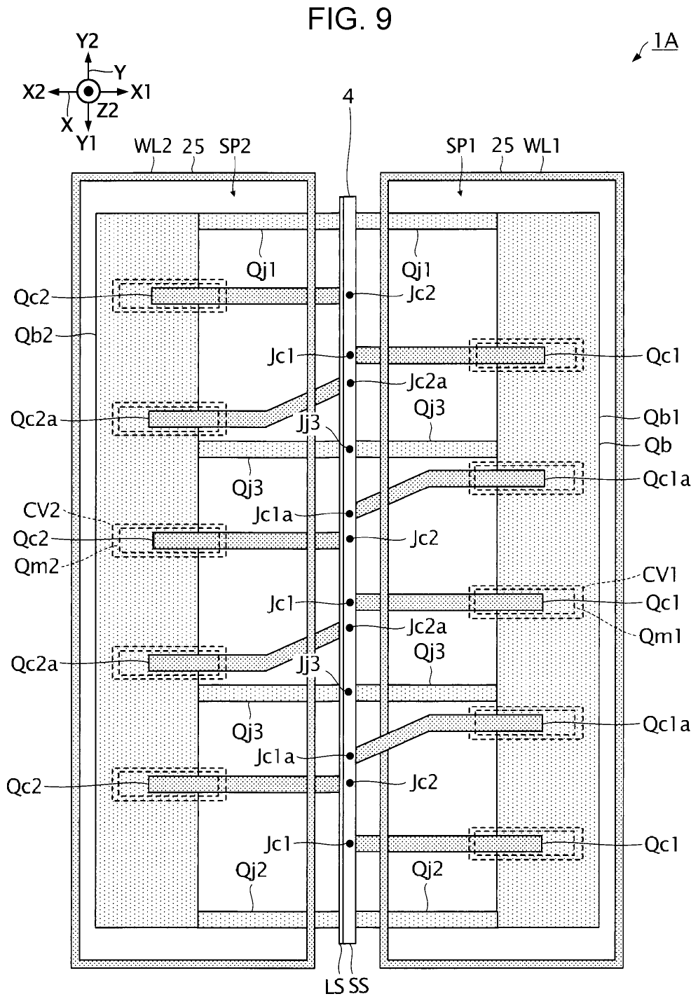

Hereinafter, a liquid ejecting apparatus 100 according to a second embodiment will be described with reference to FIG. 9. For the sake of simplicity in description, differences between the liquid ejecting apparatus 100 according to the second embodiment and the liquid ejecting apparatus 100 according to the first embodiment will be mainly described below. In addition, the same reference numerals may be used for the same components as those of the liquid ejecting apparatus 100 according to the first embodiment among components provided in the liquid ejecting apparatus 100 according to the second embodiment, and the descriptions of the functions thereof may not be repeated.

### 2-1: Structure of Electrode

The liquid ejecting apparatus 100 according to the second embodiment includes a liquid ejecting head 1A instead of the liquid ejecting head 1 provided in the liquid ejecting apparatus 100 according to the first embodiment. Hereinafter, the structure of the individual electrode Qc and the common electrode Qb in the liquid ejecting head 1A according to the second embodiment will be described with reference to FIG. 9.

FIG. 9 is a plan view of the liquid ejecting head 1A when the liquid ejecting head 1A is viewed in plan view in the Z1 direction.

The liquid ejecting head 1A includes a first individual electrode Qc1a instead of the first individual electrode Qc1 adjacent to the third coupling electrode Qj3 in the Y axis direction, unlike the liquid ejecting head 1. Similarly, the liquid ejecting head 1A includes a second individual electrode Qc2a instead of the second individual electrode Qc2 adjacent to the third coupling electrode Qj3 in the Y axis direction, unlike the liquid ejecting head 1.

An X2-side end portion of the first individual electrode Qc1a is located in the Y1 direction with respect to an X1-side end portion in the XY plane, unlike the first individual electrode Qc1. The first individual electrode Qc1a may have a bent shape in the XY plane as shown in FIG. 9 or may have a linear shape inclined with respect to the Y axis.

An X1-side end portion of the second individual electrode Qc2a is located in the Y2 direction with respect to an X2-side end portion in the XY plane, unlike the second individual electrode Qc2. The second individual electrode Qc2a may have a bent shape in the XY plane as shown in FIG. 9 or may have a linear shape inclined with respect to the Y axis.

Hereinafter, the coupling point between the first individual electrode Qc1 and the individual wiring line Wc will be referred to as a coupling point Jc1. The coupling point between the second individual electrode Qc2 and the individual wiring line Wc will be referred to as a coupling point Jc2. The coupling point between the first individual electrode Qc1a and the individual wiring line Wc will be referred to as a coupling point Jc1a. The coupling point between the second individual electrode Qc2a and the individual wiring line Wc will be referred to as a coupling point Jc2a. Additionally, hereinafter, the coupling point Jc1, the coupling point Jc2, the coupling point Jc1a, and the coupling point Jc2a will be collectively referred to as a coupling point Jcc.

Further, hereinafter, the coupling point between the third coupling electrode Qj3 and the third common wiring line Wb3 will be referred to as a coupling point Jj3.

In the wiring substrate 4 provided in the liquid ejecting head 1A, the common electrode Qb and the individual electrode Qc are provided such that the coupling point Jj3 is not interposed between the coupling point Jc1 and the coupling point Jc2 adjacent to each other among a plurality of the coupling points Jcc. In addition, in the wiring substrate 4 provided in the liquid ejecting head 1A, the common electrode Qb and the individual electrode Qc are provided such that the coupling point Jj3 is interposed between the coupling point Jc1a and the coupling point Jc2a adjacent to each other among the plurality of coupling points Jcc.

In the wiring substrate 4, the coupling point Jc1 between the first individual electrode Qc1 and the individual wiring line Wc and the coupling point Jc2 between the second individual electrode Qc2 and the individual wiring line Wc are adjacent to each other in the Y axis direction without interposing the coupling point Jj3 between the third coupling electrode Qj3 and the third common wiring line Wb3 therebetween. On the other hand, the coupling point Jc1a between the first individual electrode Qc1a and the individual wiring line Wc and the coupling point Jc2a between the second individual electrode Qc2a and the individual wiring line Wc are adjacent to each other in the Y axis direction with the coupling point Jj3 between the third coupling electrode Qj3 and the third common wiring line Wb3 interposed therebetween.

The X2-side end portion of the first individual electrode Qc1 is at the same position as the X1-side end portion in the Y axis direction. Meanwhile, as described above, the X2-side end portion of the first individual electrode Qc1a is located in the Y1 direction with respect to the X1-side end portion in the XY plane.

Additionally, the X1-side end portion of the second individual electrode Qc2 is at the same position as the X2-side end portion in the Y axis direction. Meanwhile, as described above, the X1-side end portion of the second individual electrode Qc2a is located in the Y2 direction with respect to the X2-side end portion in the XY plane.

Therefore, the interval between the coupling point Jc1a and the coupling point Jc2a is larger than the interval between the coupling point Jc1 and the coupling point Jc2.

The coupling point Jc1a is an example of a “first coupling point”. The coupling point Jc2a is an example of a “second coupling point”. The coupling point Jc1 is an example of a “third coupling point”. The coupling point Jc2 is an example of a “fourth coupling point”.

### 2-2: Effect of Second Embodiment

In the liquid ejecting head 1A according to the present embodiment, the coupling point Jj3 between the third common wiring line Wb3 and the third coupling electrode Qj3 is interposed between the coupling point Jc1a and the coupling point Jc2a adjacent to each other in the Y axis direction, among the coupling points Jcc between the individual wiring lines Wc and the individual electrodes Qc. The coupling point Jj3 between the third common wiring line Wb3 and the third coupling electrode Qj3 is not interposed between the coupling point Jc1 and the coupling point Jc2 adjacent to each other in the Y axis direction, among the coupling points Jcc between the individual wiring lines Wc and the individual electrodes Qc. The interval between the coupling point Jc1a and the coupling point Jc2a in the Y axis direction is larger than the interval between the coupling point Jc1 and the coupling point Jc2 in the Y axis direction.

By making the interval between the coupling point Jc1a and the coupling point Jc2a, which interpose the coupling point Jj3, larger than the interval between the coupling point Jc1 and the coupling point Jc2, which do not interpose the coupling point Jj3, noise induced in the third coupling electrode Qj3 having the coupling point Jj3 can be suppressed.

### 3: Third Embodiment

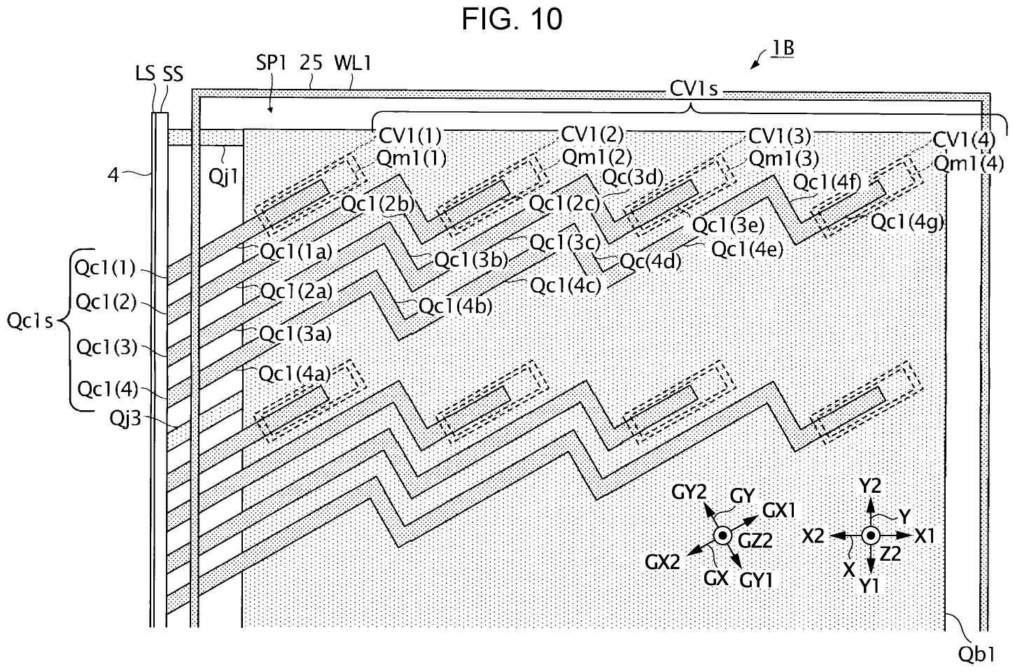

Hereinafter, a liquid ejecting apparatus 100 according to a third embodiment will be described with reference to FIG. 10. For the sake of simplicity in description, differences between the liquid ejecting apparatus 100 according to the third embodiment and the liquid ejecting apparatus 100 according to the first embodiment will be mainly described below. In addition, the same reference numerals may be used for the same components as those of the liquid ejecting apparatus 100 according to the first embodiment among components provided in the liquid ejecting apparatus 100 according to the third embodiment, and the descriptions of the functions thereof may not be repeated.

### 3-1: Structure of Electrode

The liquid ejecting apparatus 100 according to the third embodiment includes a liquid ejecting head 1B instead of the liquid ejecting head 1 provided in the liquid ejecting apparatus 100 according to the first embodiment. Hereinafter, the structure of the individual electrode Qc and the common electrode Qb in the liquid ejecting head 1B according to the third embodiment will be described with reference to FIG. 10.

FIG. 10 is a plan view of the liquid ejecting head 1B when the liquid ejecting head 1B is viewed in plan view in the Z1 direction. For the sake of simplicity in description, in FIG. 10, among components provided in the liquid ejecting head 1B, the wiring substrate 4 and elements on the X1 side with respect to the wiring substrate 4 are shown.

In the liquid ejecting head 1B, the extension directions of the plurality of pressure chambers CV1 are inclined with respect to the Y axis direction.

In FIG. 10, the plurality of pressure chambers CV1 include a pressure chamber CV1(1), a pressure chamber CV1(2), a pressure chamber CV1(3), and a pressure chamber CV1(4). Hereinafter, in the liquid ejecting head 1B illustrated in FIG. 10, the pressure chamber CV1(1) to the pressure chamber CV1(4) may be collectively referred to as one pressure chamber group CV1s.

In addition, the plurality of first individual electrodes Qc1 include a first individual electrode Qc1(1), a first individual electrode Qc1(2), a first individual electrode Qc1(3), and a first individual electrode Qc1(4). Hereinafter, the first individual electrode Qc1(1) to the first individual electrode Qc1(4) that correspond to one pressure chamber group CV1s may be collectively referred to as one first individual electrode group Qc1s.

A piezoelectric body Qm1(1) is provided to correspond to the pressure chamber CV1(1). A piezoelectric body Qm1(2) is provided to correspond to the pressure chamber CV1(2). A piezoelectric body Qm1(3) is provided to correspond to the pressure chamber CV1(3). A piezoelectric body Qm1(4) is provided to correspond to the pressure chamber CV1(4).

The first individual electrode Qc1(1) is coupled to the piezoelectric body Qm1(1). The first individual electrode Qc1(1) has a linear shape in the XY plane. In addition, the extension direction of the first individual electrode Qc1(1) is inclined with respect to the Y axis direction.

Hereinafter, in the extension direction of the first individual electrode Qc1(1), a direction from the wiring substrate 4 toward the piezoelectric body Qm(1) will be referred to as a GX1 direction, and a direction opposite to the GX1 direction will be referred to as a GX2 direction. The GX1 direction and the GX2 direction will be referred to as a GX direction.

Additionally, hereinafter, in the normal direction of the first individual electrode Qc1(1), a direction that coincides with the Z1 direction will be referred to as a GZ1 direction, and a direction that coincides with the Z2 direction will be referred to as a GZ2 direction. The GZ1 direction and the GZ2 direction will be referred to as a GZ direction.

Further, Hereinafter, a direction orthogonal to both the GX direction and the GZ direction will be referred to as a GY direction. In the GY direction, a direction toward the X1 direction and the Y1 direction will be referred to as a GY1 direction. In the GY direction, a direction toward the X2 direction and the Y2 direction will be referred to as a GY2 direction.

The first individual electrode Qc1(2) is coupled to the piezoelectric body Qm1(2). The first individual electrode Qc1(2) has a bent shape in the XY plane. The first individual electrode Qc1(2) includes a first electrode part Qc1(2a), a second electrode part Qc1(2b), and a third electrode part Qc1(2c).

The first electrode part Qc1(2a) extends in the GX direction. In addition, a GX2-side end portion of the first electrode part Qc1(2a) is coupled to the individual wiring line Wc in the wiring substrate 4. Further, a GX1-side end portion of the first electrode part Qc1(2a) is coupled to the second electrode part Qc1(2b).

The second electrode part Qc1(2b) extends in the GY direction. Additionally, a GY2-side end portion of the second electrode part Qc1(2b) is coupled to the first electrode part Qc1(2a). Further, a GY1-side end portion of the second electrode part Qc1(2b) is coupled to the third electrode part Qc1(2c).

The third electrode part Qc1(2c) extends in the GX direction. In addition, a GX2-side end portion of the third electrode part Qc1(2c) is coupled to the second electrode part Qc1(2b). Further, a GX1-side end portion of the third electrode part Qc1(2c) is coupled to the piezoelectric body Qm1(2).

The first individual electrode Qc1(3) is coupled to the piezoelectric body Qm1(3). The first individual electrode Qc1(3) has a bent shape in the XY plane. The first individual electrode Qc1(3) includes a first electrode part Qc1(3a), a second electrode part Qc1(3b), a third electrode part Qc1(3c), a fourth electrode part Qc1(3d), and a fifth electrode part Qc1(3e).

The first electrode part Qc1(3a) extends in the GX direction. Additionally, a GX2-side end portion of the first electrode part Qc1(3a) is coupled to the individual wiring line Wc in the wiring substrate 4. Further, a GX1-side end portion of the first electrode part Qc1(3a) is coupled to the second electrode part Qc1(3b).

The second electrode part Qc1(3b) extends in the GY direction. In addition, a GY2-side end portion of the second electrode part Qc1(3b) is coupled to the first electrode part Qc1(3a). Further, a GY1-side end portion of the second electrode part Qc1(3b) is coupled to the third electrode part Qc1(3c).

The third electrode part Qc1(3c) extends in the GX direction. Additionally, a GX2-side end portion of the third electrode part Qc1(3c) is coupled to the second electrode part Qc1(3b). Further, a GX1-side end portion of the third electrode part Qc1(3c) is coupled to the fourth electrode part Qc1(3d).

The fourth electrode part Qc1(3d) extends in the GY direction. In addition, a GY2-side end portion of the fourth electrode part Qc1(3d) is coupled to the third electrode part Qc1(3c). Further, a GY1-side end portion of the fourth electrode part Qc1(3d) is coupled to the fifth electrode part Qc1(3e).

The fifth electrode part Qc1(3e) extends in the GX direction. Additionally, a GX2-side end portion of the fifth electrode part Qc1(3e) is coupled to the fourth electrode part Qc1(3d). In addition, a GX1-side end portion of the fifth electrode part Qc1(3e) is coupled to the piezoelectric body Qm1(3).

The first individual electrode Qc1(4) is coupled to the piezoelectric body Qm1(4). The first individual electrode Qc1(4) has a bent shape in the XY plane. The first individual electrode Qc1(4) includes a first electrode part Qc1(4a), a second electrode part Qc1(4b), a third electrode part Qc1(4c), a fourth electrode part Qc1(4d), a fifth electrode part Qc1(4e), a sixth electrode part Qc1(4f), and a seventh electrode part Qc1(4g). The first electrode part Qc1(4a) extends in the GX direction. In addition, a GX2-side end portion of the first electrode part Qc1(4a) is coupled to the individual wiring line Wc in the wiring substrate 4. Further, a GX1-side end portion of the first electrode part Qc1(4a) is coupled to the second electrode part Qc1(4b).

The second electrode part Qc1(4b) extends in the GY direction. Additionally, a GY2-side end portion of the second electrode part Qc1(4b) is coupled to the first electrode part Qc1(4a). Further, a GY1-side end portion of the second electrode part Qc1(4b) is coupled to the third electrode part Qc1(4c).

The third electrode part Qc1(4c) extends in the GX direction. In addition, a GX2-side end portion of the third electrode part Qc1(4c) is coupled to the second electrode part Qc1(4b). Further, a GX1-side end portion of the third electrode part Qc1(4c) is coupled to the fourth electrode part Qc1(4d).

The fourth electrode part Qc1(4d) extends in the GY direction. Additionally, a GY2-side end portion of the fourth electrode part Qc1(4d) is coupled to the third electrode part Qc1(4c). Further, a GY1-side end portion of the fourth electrode part Qc1(4d) is coupled to the fifth electrode part Qc1(4e).

The fifth electrode part Qc1(4e) extends in the GX direction. In addition, a GX2-side end portion of the fifth electrode part Qc1(4e) is coupled to the fourth electrode part Qc1(4d). Further, a GX1-side end portion of the fifth electrode part Qc1(4e) is coupled to the sixth electrode part Qc1(4f).

The sixth electrode part Qc1(4f) extends in the GY direction. Additionally, a GY2-side end portion of the sixth electrode part Qc1(4f) is coupled to the fifth electrode part Qc1(4e). Further, a GY1-side end portion of the sixth electrode part Qc1(4f) is coupled to the seventh electrode part Qc1(4g).

The seventh electrode part Qc1(4g) extends in the GX direction. In addition, a GX2-side end portion of the seventh electrode part Qc1(4g) is coupled to the sixth electrode part Qc1(4f). Further, a GX1-side end portion of the seventh electrode part Qc1(4g) is coupled to the piezoelectric body Qm1(4).

The third coupling electrode Qj3 is installed between two first individual electrode groups Qc1s. The extension direction of the third coupling electrode Qj3 is inclined with respect to the Y axis direction.

In the example shown in FIG. 10, the first individual electrode Qc1(2) to the first individual electrode Qc1(4) have bent shapes in the XY plane but may have linear shapes.

In addition, in FIG. 10, as an example, one pressure chamber group CVIs includes four pressure chambers CV1. However, the number of pressure chambers CV1 included in one pressure chamber group CVIs may be one to three, or may be five or more. Similarly, in FIG. 10, as an example, one first individual electrode group Qcs includes four first individual electrodes Qc1. However, the number of first individual electrodes Qc1 included in one first individual electrode group Qc1s may be one to three, or may be five or more.

### 4: Modification Examples

Each of the above embodiments may be variously modified. Specific aspects of modifications will be described below. The aspects exemplified below and the aspects described in the above embodiments may be combined as appropriate within the scope of not being mutually inconsistent. In the modification examples exemplified below, for elements that have effects and functions equivalent to those in the embodiments, the same reference numerals as described above will be used, and detailed descriptions of each element will not be repeated as appropriate.

### 4-1: Modification Example 1

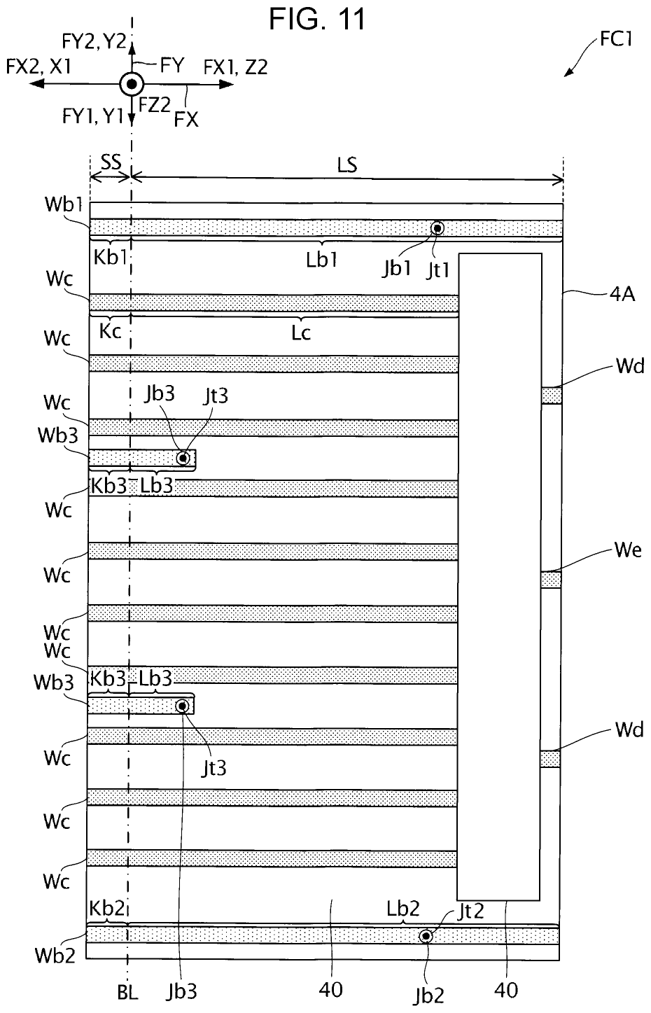

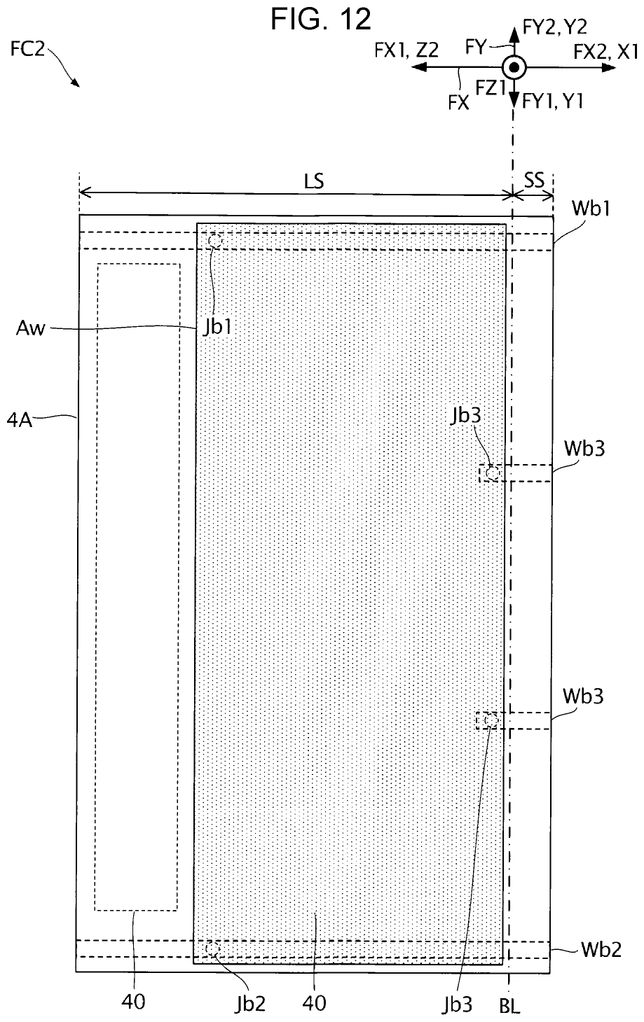

FIGS. 11 and 12 are explanatory diagrams illustrating various wiring lines provided on a wiring substrate 4A according to the present modification example.

FIG. 11 is a configuration diagram of the wiring substrate 4A illustrating the arrangement of the wiring lines and electronic components provided on the first surface FC1 when the first surface FC1 of the wiring substrate 4A is viewed from the FZ2 side toward the FZ1 side.

FIG. 12 is a configuration diagram of the wiring substrate 4A illustrating the arrangement of the wiring lines provided on the second surface FC2 when the second surface FC2 of the wiring substrate 4A is viewed from the FZ1 side toward the FZ2 side. In FIG. 12, for convenience of description, a part of the wiring lines and electronic components provided on the first surface FC1 is shown by dashed lines.

In the first embodiment, when the wiring substrate 4 is viewed in plan view in the FZ direction, the auxiliary wiring line Aw and the integrated circuit 40 are installed at positions that overlap each other. On the other hand, as in the present modification example shown in FIGS. 11 and 12, when the wiring substrate 4A is viewed in plan view in the FZ direction, the auxiliary wiring line Aw and the integrated circuit 40 may be installed at positions that do not overlap each other.

By not installing the auxiliary wiring line Aw at a location that corresponds to the integrated circuit 40 in the second surface FC2, the occurrence of noise in the integrated circuit 40 is suppressed.

What is claimed is:

1. A liquid ejecting head comprising:
a nozzle substrate provided with a nozzle for ejecting a liquid;
a pressure chamber substrate provided with a plurality of pressure chambers for applying pressure to the liquid;
a piezoelectric element including a piezoelectric body, an individual electrode individually provided for each of the plurality of pressure chambers, and a common electrode provided in common to the plurality of pressure chambers; and
a wiring substrate provided with an individual wiring line for applying a voltage to the individual electrode, a common wiring line for applying a voltage to the common electrode, and an auxiliary wiring line that is electrically coupled to the common wiring line to reduce resistance of the common electrode.

2. The liquid ejecting head according to claim 1, wherein
the individual wiring line and the common wiring line are provided on a first surface of the wiring substrate, and
the auxiliary wiring line is provided on a second surface on a back of the first surface of the wiring substrate.

3. The liquid ejecting head according to claim 1, wherein
the common wiring line and the auxiliary wiring line are electrically coupled through a through-hole installed in the wiring substrate.

4. The liquid ejecting head according to claim 2, wherein
the wiring substrate is further provided with an integrated circuit to which the individual wiring line is coupled, and
when the wiring substrate is viewed in plan view, the auxiliary wiring line and the integrated circuit are installed at positions that overlap each other.

5. The liquid ejecting head according to claim 2, wherein
the wiring substrate is further provided with an integrated circuit to which the individual wiring line is coupled, and
when the wiring substrate is viewed in plan view, the auxiliary wiring line and the integrated circuit are installed at positions that do not overlap each other.

6. The liquid ejecting head according to claim 1, wherein
the common wiring line includes a first common wiring line and a second common wiring line, and
the auxiliary wiring line electrically couples the first common wiring line and the second common wiring line.

7. The liquid ejecting head according to claim 6, wherein
when an arrangement direction of the plurality of pressure chambers is a first direction,
the first common wiring line is coupled to the common electrode on one side along the first direction with respect to a coupling position between the individual electrode and the individual wiring line, and
the second common wiring line is coupled to the common electrode on another side along the first direction with respect to the coupling position between the individual electrode and the individual wiring line.

8. The liquid ejecting head according to claim 6, further comprising:
a third common wiring line installed between the first common wiring line and the second common wiring line in a first direction, which is an arrangement direction of the plurality of pressure chambers, the third common wiring line electrically coupling the common electrode and the auxiliary wiring line.

9. The liquid ejecting head according to claim 8, wherein
the first common wiring line is electrically coupled to the auxiliary wiring line at a coupling point located in a middle of the first common wiring line, and
the third common wiring line is electrically coupled to the auxiliary wiring line at one end of the third common wiring line.

10. The liquid ejecting head according to claim 1, wherein
a cross-sectional area of the auxiliary wiring line is larger than a cross-sectional area of the individual wiring line.

11. The liquid ejecting head according to claim 1, wherein
the common electrode is installed on a surface of the piezoelectric body opposite to a surface of the piezoelectric body on a pressure chamber side, and
the individual electrode is installed on the surface of the piezoelectric body on the pressure chamber side.

12. The liquid ejecting head according to claim 1, wherein
when an arrangement direction of the plurality of pressure chambers is a first direction,
in a case where, among coupling points between the individual wiring lines and the individual electrodes, a coupling point between the common wiring line and the common electrode is interposed between a first coupling point and a second coupling point adjacent to each other in the first direction, and
among the coupling points between the individual wiring lines and the individual electrodes, the coupling point between the common wiring line and the common electrode is not interposed between a third coupling point and a fourth coupling point adjacent to each other in the first direction,
an interval between the first coupling point and the second coupling point in the first direction is larger than an interval between the third coupling point and the fourth coupling point in the first direction.

13. A liquid ejecting apparatus comprising:
the liquid ejecting head according to claim 1; and
a control device that controls an ejection operation of the liquid from the liquid ejecting head.
